(19) United States
(12) Patent Application Publication
(10) Pub. No.: US 2014/0115408 A1
(43) Pub. Date: Apr. 24, 2014

(54) MAXIMUM FREQUENCY AND MINIMUM VOLTAGE DISCOVERY

(71) Applicant: BROADCOM CORPORATION, Irvine, CA (US)

(72) Inventors: Ivan Andrejic, St. Neots (GB); Terence Leslie Mackown, Histon (GB)

(73) Assignee: BROADCOM CORPORATION, Irvine, CA (US)

(21) Appl. No.: 13/659,369

(22) Filed: Oct. 24, 2012

(51) Int. Cl. G06F 11/07

(52) U.S. Cl. 714/55; 714/E11.024

(57) ABSTRACT

Selection of a minimum voltage and/or maximum clock frequency in an integrated circuit is described. Selection of the minimum voltage and/or maximum clock frequency is accomplished by generating a timing error prediction signal and a timing error detection signal in a timing error module that is placed in a critical path in the integrated circuit.

### BACKGROUND

Integrated circuits, such as processors, processing circuitry, or other devices that incorporate semiconductor devices, can have varying clock frequencies as well as operating voltages. In the context of mobile devices, minimizing power consumption of the processor(s), integrated circuits, and other components is often a paramount concern. For example, in order to minimize power consumption and/or alter device performance, the clock frequency of the various components in a device as well as the operating voltage can be manipulated. However, manipulating clock frequencies and/or operating voltage within a device can also cause device instability due to the variations from device to device with respect to semiconductor purity and/or age.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a drawing of a computing device incorporating an integrated circuit and a frequency selection module according to an embodiment of the disclosure.

FIG. 1B is a drawing of a computing device incorporating an integrated circuit and a voltage selection module according to an embodiment of the disclosure.

FIG. 2 is a drawing of one example of components in an integrated circuit according to one embodiment of the disclosure.

FIG. 3 is a drawing of one example of a timing error module employed in an integrated circuit according to an embodiment of the disclosure.

FIG. 4 is a drawing of flowchart illustrating a method according to one embodiment of the disclosure.

FIG. 5 is a drawing of flowchart illustrating a method according to one embodiment of the disclosure.

### DETAILED DESCRIPTION

Embodiments of the present disclosure are related to discovering a maximum clock frequency associated with an electronic device. Some embodiments of the present disclosure are also related to discovering a minimum voltage associated with an electronic device. More generally speaking, embodiments of the disclosure are directed to predicting as well as detecting timing errors in an integrated circuit where the clock frequency and/or voltage levels are adjusted. For example, a clock frequency of a clock signal associated with an integrated circuit can be increased to improve the performance of circuitry that uses the clock signal. As another example, a source of input voltage level of an integrated circuit can be adjusted to reduce power consumption of the circuit.

Dynamic voltage and frequency scaling (DVFS) is a technique employed in computing devices and/or integrated circuits to manage clock frequency as well as operating voltage for the purpose of power management and managing device performance. However, DVFS can pose diminishing returns when used, for example, with semiconductor designs incorporating small geometries due to power leakage and other concerns. Accordingly, rather than merely lowering clock frequencies as a method to conserve power in a device, an alternative methodology in which the clock frequency employed by a device is maximized so that the device can complete its operations quickly as possible and then power off to reduce or eliminate power leakages that occur when a device and/or circuit is powered on.

Maximizing the clock frequency of an integrated circuit can introduce timing errors into a device, which can lead to device instability, improper execution of software, and other issues that affect performance of an integrated circuit as can be appreciated. Additionally, the maximum clock frequency of two circuits of an identical or similar design can vary due to issues such as semiconductor purity and age. As another issue, the maximum clock frequency that a device can handle without experiencing timing errors can also change over time as the device ages. A maximum clock frequency can also vary as a function of process variation and temperature from device to device. Accordingly, a maximum clock frequency of a device may vary due to environmental conditions and other factors as can be appreciated. Therefore, embodiments of the disclosure can facilitate determination of a maximum clock frequency of an integrated circuit that does not cause timing errors or instability of the integrated circuit.

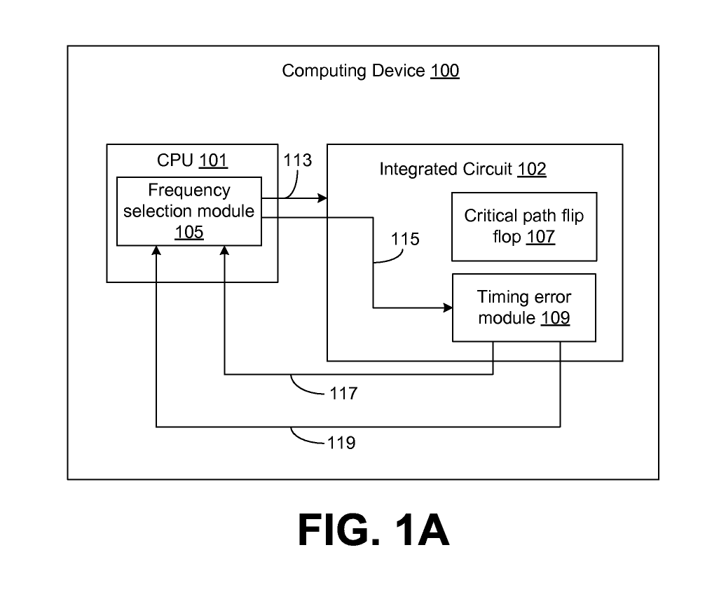

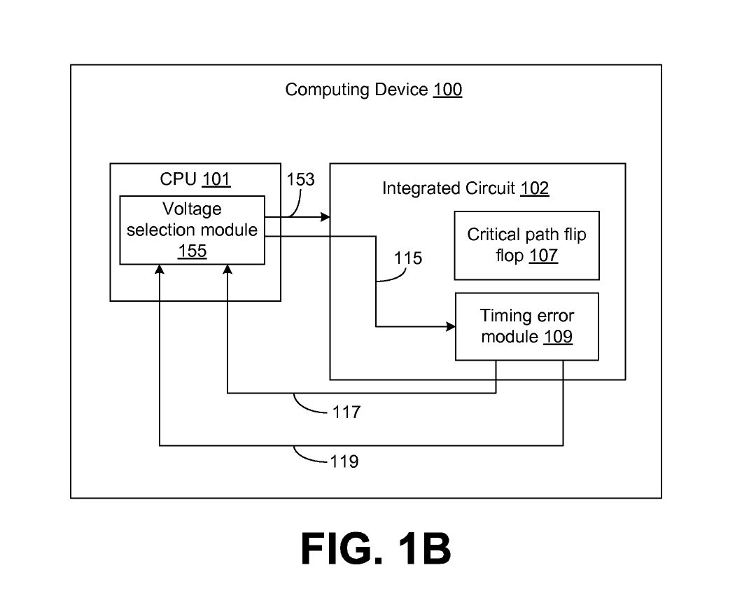

Therefore, with reference to FIG. 1A, shown is an example of a computing device 100 according to one embodiment of the disclosure. In the depicted embodiment, the computing device 100 comprises a central processing unit (CPU) 101 as well as an integrated circuit 102. The computing device 100 may comprise additional CPU's, processing circuitry, integrated circuits, processors, input/output interfaces, network interfaces, and/or other components as can be appreciated. The integrated circuit 102 can comprise any electronic device, circuit, processor, system and/or subsystem that relies upon a clock signal as well as an input voltage in order to operate. For example, the integrated circuit 102 can comprise a graphics subsystem, a wireless networking interface, a system on a chip (SoC), or any other processing circuitry or components employing an integrated circuit, as can be appreciated.

The CPU 101 includes a frequency selection module 105, which can be a software and/or firmware process that is executed by the CPU in order to select a clock frequency that is employed by the integrated circuit 102. The frequency selection module 105 can also be implemented in hardware logic within the CPU 101 or external to the CPU 101. The frequency selection module 105 can also be implemented in dedicated hardware or other forms of processing circuitry. The depicted implementation is only one example shown for the purposes of illustrating the concepts of various embodiments of the present disclosure.

The frequency selection module 105 is operable to select a clock frequency 113 that is communicated to and employed by the integrated circuit 102. The clock frequency 113 can be selected by the frequency selection module 105 to specify the frequency of the clock signal that is employed by the integrated circuit 102 as well as the components within the integrated circuit, such as various logic gates or other circuitry as can be appreciated. It should also be appreciated that in some embodiments, the integrated circuit 102 may derive other clock signals at other frequencies that are derived from the clock frequency 113 provided by the frequency selection module 105.

The integrated circuit 102 can facilitate discovery of a maximum clock frequency by employing one or more critical path flip flops 107 that are configured in parallel with one or more timing error modules 109. The critical path flip flop 107 and timing error module 109 can be placed within a critical path of the integrated circuit 102, or any path at which timing errors can occur due to a clock frequency that is too high.

The frequency selection module 105 can determine a clock frequency for the integrated circuit 102 in response to a timing error prediction 117, or a timing error warning, as well as a timing error detection 119 that are generated by the timing error module 109. The timing error prediction 117 and timing error detection 119 represent a respective prediction and detection of a timing error relative to the critical path flip flop 107. In other words, the timing error module 109 can predict as well as detect an actual occurrence of a timing error relative to the critical path flip flop 107 that is caused by the use of a particular input clock frequency 113 by the integrated circuit 102. The timing error module 109 generates a timing error prediction 117 and/or timing error detection 119 based at least in part upon an input signal as well as a clock signal at a particular clock frequency 113 that is provided to the timing error module 109 and the critical path flip flop 107, which are configured in parallel.

The timing error module 109 incorporates a flip flop, which is also referred to as a “canary” flip flop and introduces a delay to the input signal, which is in turn provided to the canary flip flop. The timing error module 109 then generates a timing error prediction 117 based upon whether the output value of the canary flip flop is equivalent to the critical path flip flop 107. To generate the timing error prediction 117, the canary flip flop and the critical path flip flop 107 are provided the same clock signal. Additionally, the timing error module 109 also incorporates a second flip flop, referred to as a “shadow” flip flop, to which the input signal as well as a delayed clock signal is provided. Accordingly, the timing error module 109 generates a timing error detection 119 which can represent the actual occurrence of a timing error, based upon whether a timing error exists between the output of the shadow flip flop and the critical path flip flop 107.

Other solutions incorporating a canary flip flop can generate a timing error prediction but fail to generate a timing error detection. Additionally, in certain situations, other solutions can also generate a timing error prediction that in effect reflects a false positive scenario. In other words, such a false positive scenario can be such that other solutions fail to predict a timing error when in fact that a particular clock frequency is causing a timing error. In other words, certain timing errors are essentially undetectable by other solutions.

To generate a timing error prediction 117, the timing error module 109 receives as an input at least one delay signal 115 from the frequency selection module 105, which represents an amount by which to delay the input signal that is provided to the canary flip flop within the timing error module 109. The delay signal 115 can also be employed by the timing error module 109 to generate a timing error detection 119, which can specify an amount by which to delay the clock signal that is provided to the shadow flip flop. Based upon the timing error prediction 117 and/or timing error detection 119 signals that are generated by the timing error module 109, the frequency selection module 105 can specify a particular clock frequency 113 as well as a particular delay signal 115 that the timing error module 109 in turn employs to generate a subsequent timing error prediction and timing error detection 119.

In this sense, embodiments of the disclosure provide a feedback loop through which timing errors that occur within the integrated circuit 102 can be continually predicted and detected by the timing error module 109, and to which the frequency selection module 105 can respond by modifying the clock frequency 113 at which the integrated circuit 102 operates. The manner in which the frequency selection module 105 can respond to a timing error prediction 117 and/or timing error detection 119 by modifying the delay signal 115 and/or clock frequency 113 is discussed in further detail below.

As noted above, embodiments of the disclosure can also be configured with a voltage selection module 155 that selects a voltage level 153 employed by the integrated circuit 102. Therefore, with reference to FIG. 1B, shown is an alternative example of a computing device 100 according to one embodiment of the disclosure. In the depicted embodiment, similar to the embodiment shown in FIG. 1B, the computing device 100 also comprises a CPU 101 as well as an integrated circuit 102.

The voltage selection module 155 is operable to select a voltage level 153 that is communicated to and employed by the integrated circuit 102. The voltage level 153 can be selected by the frequency selection module 105 to specify the voltage levels that are employed by the integrated circuit 102 as well as the components within the integrated circuit, such as various logic gates or other circuitry as can be appreciated. It should also be appreciated that in some embodiments, the integrated circuit 102 may derive other voltages from the voltage level 153 provided by the frequency selection module 105. For example, the voltage level 153 may specify a maximum voltage level that may be employed within the integrated circuit 102.

The integrated circuit 102 can facilitate discovery of a maximum voltage level by also employing one or more critical path flip flops 107 that are configured in parallel with one or more timing error modules 109 as shown in the example of FIG. 1A. The critical path flip flop 107 and timing error module 109 can be placed within a critical path of the integrated circuit 102, or any path at which timing errors can occur due to a voltage that is too low.

The voltage selection module 155 can determine a voltage level 153 for the integrated circuit 102 in response to a timing error prediction 117, or a timing error warning, as well as a timing error detection 119 that are generated by the timing error module 109, where the timing error prediction 117 and timing error detection 119 represent a respective prediction and detection of a timing error relative to the critical path flip flop 107. In other words, the timing error module 109 can predict as well as detect an actual occurrence of a timing error relative to the critical path flip flop 107 that is caused by the use of a particular input voltage level 153 by the integrated circuit 102. The timing error module 109 generates a timing error prediction 117 and/or timing error detection 119 based at least in part upon an input signal as well as a clock signal at a particular voltage level 153 that is provided to the timing error module 109 and the critical path flip flop 107, which are configured in parallel.

As in the example of FIG. 1A, the timing error module 109 incorporates a flip flop, which is also referred to as a “canary” flip flop and introduces a delay to the input signal, which is in turn provided to the canary flip flop. The timing error module 109 then generates a timing error prediction 117 based upon whether the output value of the canary flip flop is equivalent to the critical path flip flop 107. To generate the timing error prediction 117, the canary flip flop and the critical path flip flop 107 are provided the same clock signal. Additionally, the timing error module 109 also incorporates a second flip flop, referred to as a “shadow” flip flop, to which the input signal as well as a delayed clock signal is provided. Accordingly, the timing error module 109 generates a timing error detection 119 which can represent the actual occurrence of a timing error, based upon whether a timing error exists between the output of the shadow flip flop and the critical path flip flop 107.

Other solutions incorporating a canary flip flop can generate a timing error prediction but fail to generate a timing error detection. Additionally, in certain situations, other solutions can also generate a timing error prediction that in effect reflects a false positive scenario. In other words, such a false positive scenario can be such that other solutions fail to predict a timing error when in fact that a particular voltage level is causing a timing error. In other words, certain timing errors are essentially undetectable by other solutions.

To generate a timing error prediction 117, the timing error module 109 receives as an input at least one delay signal 115 from the frequency selection module 105, which represents an amount by which to delay the input signal that is provided to the canary flip flop within the timing error module 109. The delay signal 115 can also be employed by the timing error module 109 to generate a timing error detection 119, which can specify an amount by which to delay the clock signal that is provided to the shadow flip flop. Based upon the timing error prediction 117 and/or timing error detection 119 signals that are generated by the timing error module 109, the frequency selection module 105 can specify a particular voltage level 153 as well as a particular delay signal 115 that the timing error module 109 in turn employs to generate a subsequent timing error prediction and timing error detection 119.

In this sense, embodiments of the disclosure provide a feedback loop through which timing errors that occur within the integrated circuit 102 can be continually predicted and detected by the timing error module 109, and to which the voltage selection module 155 can respond by modifying the voltage level 153 at which the integrated circuit 102 operates. Accordingly, the voltage selection module 155 can operate in response to data provided by the timing error module 109 just as in the previous example of FIG. 1A of the frequency selection module 105. The manner in which the voltage selection module 155 can respond to a timing error prediction 117 and/or timing error detection 119 by modifying the delay signal 115 and/or voltage level 153 is discussed in further detail below.

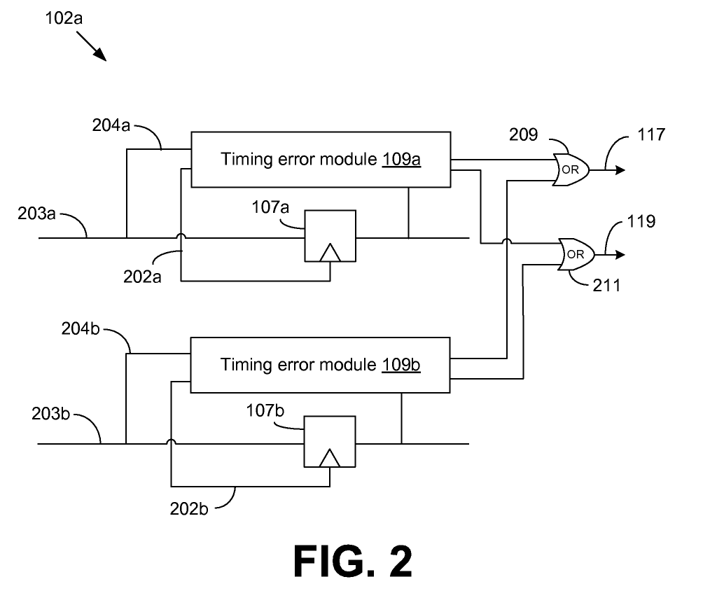

Reference is now made to FIG. 2, which illustrates an example of an integrated circuit 102a incorporating more than one critical path flip flop 107a, 107b and a corresponding timing error module 109a, 109b to detect timing errors potentially in multiple critical paths 203a, 203b and/or multiple areas within the integrated circuit. As shown in the example of FIG. 2, the integrated circuit 102a can employ multiple timing error modules 109a, 109b that are placed in parallel with respective critical path flip flop 107a, 107b for the purpose of generating a timing error prediction 117 as well as a timing error detection 119 for the integrated circuit.

To generate a timing error prediction 117, the timing error module 109a, 109b is provided a clock signal 202a, 202b that is also provided to the critical path flip flop 107a, 107b. Additionally, the timing error module 109a, 109b is also provided the input signal 204a, 204b that is also provided to the critical path flip flop 107a, 107b. The timing error module 109a, 109b is further provided a delay signal 115 from the frequency selection module 105 as shown in FIG. 1A, which configures the delay applied to the input signal 204a, 204b, and the clock signal 202a, 202b, respectively.

In the example of FIG. 2, the timing error prediction 117 generated by each of the timing error modules 109a, 109b can be provided to a logical OR gate 209 such that if either of the timing error modules 109a, 109b generate a timing error prediction 117, the integrated circuit 102a can provide the timing error prediction 117 to the frequency selection module 105. In other words, if either of the timing error predictions 117 from either of the timing error modules 109a, 109b are true, the timing error prediction 117 provided to the frequency selection module 105 are also true.

Similarly, the timing error detection 119 generated by each of the timing error modules 109a, 109b can be provided to a logical OR gate 211 such that if either of the timing error modules 109a, 109b generate a timing error detection 119, the integrated circuit 102a can provide the timing error prediction 117 to the frequency selection module 105. In other words, if either of the timing error detections 119 from either of the timing error modules 109a, 109b are true, the timing error detections 119 provided to the frequency selection module 105 are also true.

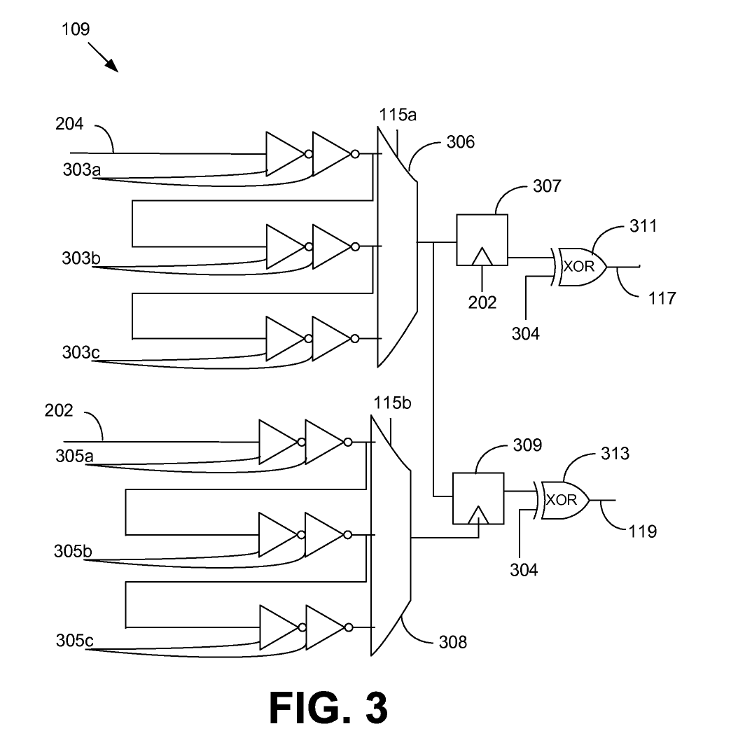

Reference is now made to FIG. 3, which illustrates an example of a timing error module 109 (FIG. 1A) according to one embodiment of the disclosure. As describe above, the timing error module 109 can generate a timing error prediction 117 as well as a timing error detection 119. The timing error prediction 117 corresponds to a prediction regarding whether a given clock frequency for a clock signal employed by the integrated circuit 102 (FIG. 1A) is likely to cause a timing error within the integrated circuit. Accordingly, the input signal 204 (FIG. 2) that is taken from the critical path 203 (FIG. 2) in which the timing error module 109 is positioned is delayed by an amount derived from the delay signal 115 obtained from the frequency selection module 105.

In the depicted example, the input signal 204 is provided to delay block 303a, which is implemented in the depicted example as a series of inverters. The delay block 303a is configured to impart a delay on the input signal 204 and output the delayed input signal to a multiplexer 306. Additionally, the output of the delay block 303a is coupled to the input of another delay block 303b. The output of the delay block 303b is coupled to another input of the multiplexer 306. Similarly, the output of the delay block 303b is also coupled to the input of another delay block 303c, the output of which is also coupled to another input of the multiplexer. The delay signal 115a provided by the frequency selection module 105 can be coupled to a selector input of the multiplexer. In this way, the input signal 204 can be delayed by an amount that is configurable by the frequency selection module 105. For example, the delay signal 115a can specify a minimal delay for the input signal 204 by selecting the first multiplexer input to which delay block 303a is connected. As another example, the delay signal 115a can specify a larger delay by selecting the second or third multiplexer input to which delay blocks 303a or 303b are connected, respectively.

It should be appreciated that the timing error module 109 can employ any number of delay blocks as well as various manners of implementing each of the delay blocks. Additionally, the timing error module 109 can also employ wholly differing methods and/or circuitry for creating a configurable delay of the input signal 204.

The delayed input signal 204 is then provided to the canary flip flop 307, which is clocked by the clock signal 202 that is also provided to the critical path flip flop 107 to which the timing error module 109 corresponds. The output of the canary flip flop 307 is in turn provided to the input of an exclusive OR (XOR) gate 311 along with the output signal 304 from the critical path flip flop 107 to which the timing error module 109 corresponds. The output of the XOR gate 311 comprises the timing error prediction 117. In this way, if there exists a likelihood of a timing error for a given clock frequency, the output of the XOR gate 311 will be true. In other words, if the delayed input signal that is output by the canary flip flop 307 is not synchronized with the output signal 304 of the critical path flip flop 107, the timing error module 109 generates a timing error prediction 117 corresponding to a predicted timing error.

Additionally, the clock signal 202 is also provided to delay block 305a, which is implemented in the depicted example as a series of inverters. The delay block 305a is configured to impart a delay on the clock signal 202 and output the delayed clock signal to a multiplexer 308. Additionally, the output of the delay block 305a is coupled to the input of another delay block 305b. The output of the delay block 303b is coupled to another input of the multiplexer 308. Similarly, the output of the delay block 305b is also coupled to the input of another delay block 305c, the output of which is also coupled to another input of the multiplexer 308. The delay signal 115b provided by the frequency selection module 105 can be coupled to a selector input of the multiplexer 308. In this way, the clock signal 202 can be delayed by an amount that is configurable by the frequency selection module 105. For example, the delay signal 115b can specify a minimal delay for the input signal 204 by selecting the first multiplexer input to which delay block 305a is connected. As another example, the delay signal 115b can specify a larger delay by selecting the second or third multiplexer input to which delay blocks 305a or 305b are connected, respectively. With respect to delay of an input signal and/or clock signal, the selected delay in delay blocks 305a and/or 305b can be proportional to the period of an input clock signal and/or a setup time associated with the flip flops employed in the timing error module 109.

It should be appreciated that the timing error module 109 can employ any number of delay blocks as well as various manners of implementing each of the delay blocks. Additionally, the timing error module 109 can also employ wholly differing methods and/or circuitry for creating a configurable delay of the clock signal 202.

The delayed clock signal 202 is output from the multiplexer 308 to the shadow flip flop 309, which is clocked by the delayed clock signal 202 output from the multiplexer 308. The data input of the shadow flip flop 309 is the delayed input signal that is output from multiplexer 306. The output of the shadow flip flop 309 is in turn provided to the input of an exclusive OR (XOR) gate 313 along with the output signal 304 from the critical path flip flop 107 to which the timing error module 109 corresponds. The output of the XOR gate 311 comprises the timing error detection 119. In this way, if a timing error exists in the particular path in which the timing error module 109 and critical path flip flop 107 are placed, the output of the XOR gate 311 will be true. In other words, if the delayed input signal that is output by the shadow flip flop 309, when the shadow flip flop 309 is clocked by a delayed clock signal, is not synchronized with the output signal 304 of the critical path flip flop 107, the timing error module 109 generates a timing error detection 119 corresponding to an occurrence of a timing error within the integrated circuit.

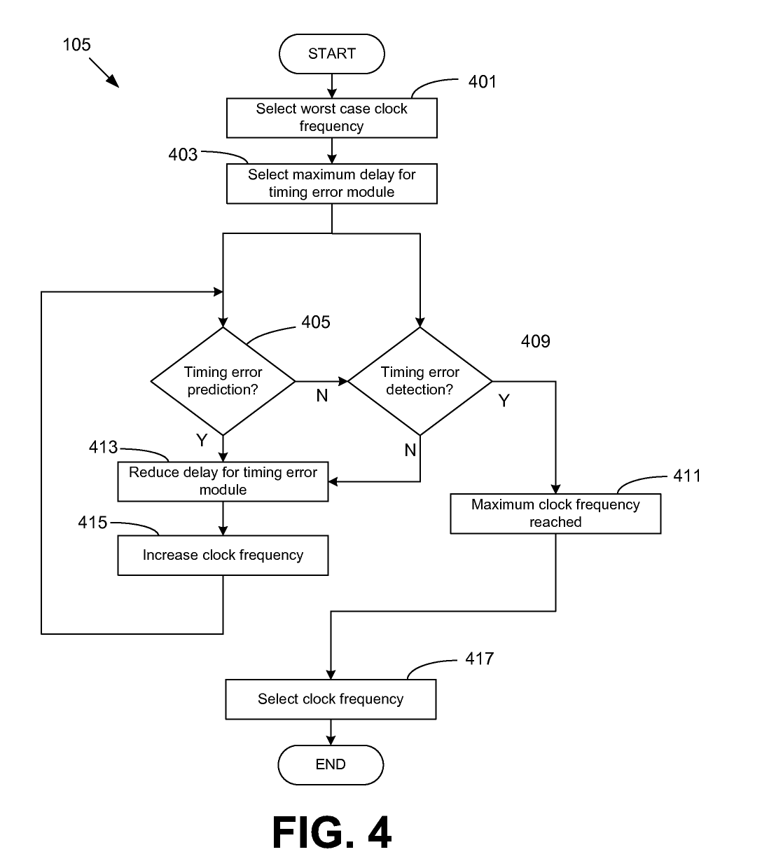

Moving on to FIG. 4, shown is a flowchart that provides one example of the operation of a portion of the frequency selection module 105 according to various embodiments. It is understood that the flowchart of FIG. 4 provides merely an example of the many different types of functional arrangements that may be employed to implement the operation of the portion of the frequency selection module 105 as described herein. As an alternative, the flowchart of FIG. 4 may be viewed as depicting an example of steps of a method implemented in the computing device 100 (FIG. 1A), the integrated circuit 102, the CPU 101, or any other hardware or software component according to one or more embodiments.

In the embodiment of FIG. 4, the frequency selection module 105 determines an approximate maximum operating frequency associated with an integrated circuit 102 based upon the timing error prediction 117 and timing error detection 119 that are generated by a timing error module 109 according to various embodiments of the disclosure. It should be appreciated that the frequency selection module 105 can determine such a clock frequency by examining inputs from multiple timing error modules 109 located in various positions and/or critical paths within the integrated circuit 102. The frequency selection module 105 can begin by selecting a worst case clock frequency for the integrated circuit 102 (401). For example, such a worst case clock frequency can be a sufficiently low frequency such that there is some assurance that the worst case clock frequency will not produce timing errors in any example of an integrated circuit 102 according to a particular design or configuration.

Next, the frequency selection module 105 can select a maximum delay signal 115 with which the timing error module 109 is configured (403). For example, the maximum delay signal 115 causes the timing error module 109 to impart a maximum delay on an input signal as well as a clock signal. Next, the frequency selection module 105 can determine whether a timing error prediction 117 is generated by the timing error module 109 (405). Additionally, the frequency selection module 105 can also determine whether a timing error detection 119 is generated by the timing error module 109 (409). Additionally, if the timing error prediction 117 is false or indicates that a timing error is not predicted by the timing error module 109, then the frequency selection module 105 also determines whether a timing error is detected by the timing error module 109 (409). In other words, the frequency selection module 105 determines whether the timing error detection 119 is true.

If the timing error detection 119 is false, the frequency selection module 105 reduces the delay signal 115 so that the timing error module 109 causes less of a delay to be imparted upon the input signal and clock signal (413). The timing error module 109 then increases the clock frequency (415) and again determines whether the increased clock frequency causes a timing error prediction 117 to be true. In one embodiment, the clock frequency 113 is increased by an amount that is proportional to the delay signal 115. Accordingly, the frequency selection module 105 can select the clock frequency of the integrated circuit such that it approaches the approximate maximum clock frequency reached in 411 when the timing error prediction 117 becomes false and the timing error detection 119 becomes true. The reason for this scenario is that the maximum clock frequency can cause a false positive timing error prediction 117 but a timing error detection 119 that is true (417). Therefore, the clock frequency selected for the integrated circuit 102 can be one that is at or near such a maximum frequency determining by the timing error module 109.

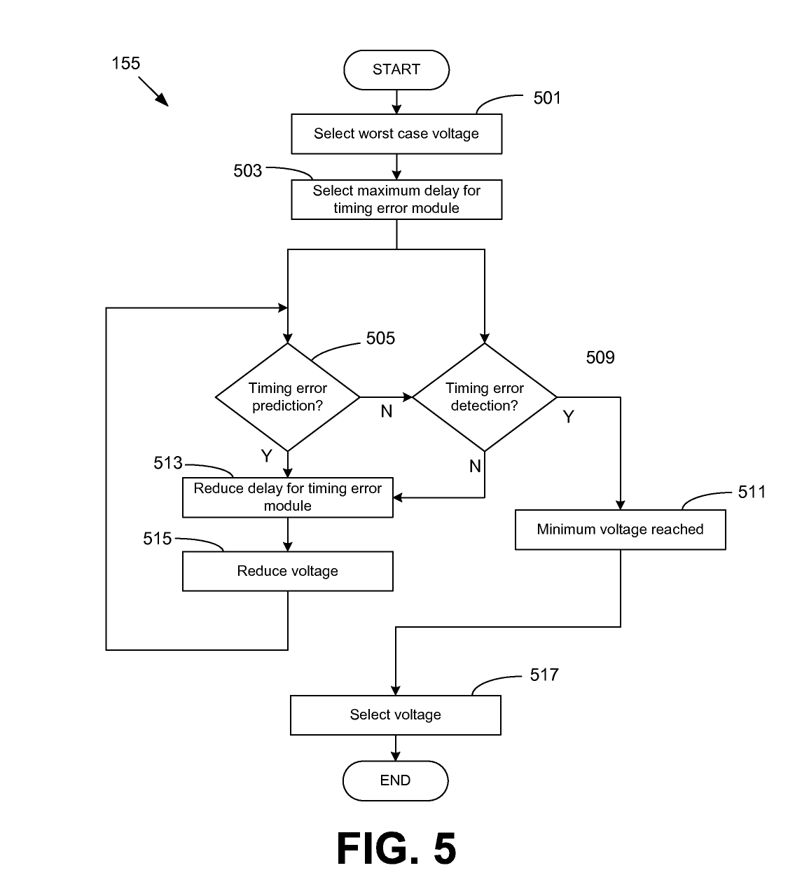

Moving on to FIG. 5, shown is a flowchart that provides one example of the operation of a portion of the voltage selection module 155 according to various embodiments. It is understood that the flowchart of FIG. 5 provides merely an example of the many different types of functional arrangements that may be employed to implement the operation of the portion of the voltage selection module 155 as described herein. As an alternative, the flowchart of FIG. 5 may be viewed as depicting an example of steps of a method implemented in the computing device 100 (FIG. 1A), the integrated circuit 102, the CPU 101, or any other hardware or software component according to one or more embodiments.

In the embodiment of FIG. 5, the voltage selection module 155 determines an approximate minimum operating voltage associated with an integrated circuit 102 based upon the timing error prediction 117 and timing error detection 119 that are generated by a timing error module 109 according to various embodiments of the disclosure. It should be appreciated that the voltage selection module 155 can determine such a minimum voltage by examining inputs from multiple timing error modules 109 located in various positions and/or critical paths within the integrated circuit 102. The voltage selection module 155 can begin by selecting a worst minimum voltage for the integrated circuit 102 (501). For example, such a worst case minimum voltage can be a sufficiently high voltage such that there is some assurance that the worst case minimum voltage will not produce timing errors in any example of an integrated circuit 102 according to a particular design or configuration.

Next, the voltage selection module 155 can select a maximum delay signal 115 with which the timing error module 109 is configured (503). For example, the maximum delay signal 115 causes the timing error module 109 to impart a maximum delay on an input signal as well as a clock signal. Next, the voltage selection module 155 can determine whether a timing error prediction 117 is generated by the timing error module 109 (505). Additionally, the voltage selection module 155 can also determine whether a timing error detection 119 is generated by the timing error module 109 (509). Additionally, if the timing error prediction 117 is false or indicates that a timing error is not predicted by the timing error module 109, then the voltage selection module 155 also determines whether a timing error is detected by the timing error module 109 (509). In other words, the voltage selection module 155 determines whether the timing error detection 119 is true.

If the timing error detection 119 is false, then the voltage selection module 155 reduces the delay signal 115 so that the timing error module 109 causes less of a delay to be imparted upon the input signal and clock signal (513). The timing error module 109 then reduces the minimum voltage (515) and again determines whether the reduced voltage causes a timing error prediction 117 to be true. In one embodiment, the voltage level 153 is reduced by an amount that is proportional to the worst case minimum voltage. The voltage selection module 155, in many embodiments, reaches the minimum voltage level of the integrated circuit 102 when the timing error prediction 117 becomes false and the timing error detection 119 becomes true (511). Accordingly, the voltage selection module 155 can select the voltage level 153 of the integrated circuit such that it approaches the approximate minimum voltage determined at 511. The reason for this scenario is that the minimum voltage level can cause a false positive timing error prediction 117 but a timing error detection 119 that is true (517). Therefore, the voltage level 153 selected for the integrated circuit 102 can be one that is at or near such a maximum frequency determining by the timing error module 109.

The frequency selection module 105 and/or voltage selection module 155 can be implemented in various ways. For example, the frequency selection module 105 and/or voltage selection module 155 can be implemented in firmware and/or software executed by a processor and/or processing circuitry. Accordingly, the frequency selection module 105 and/or voltage selection module 155 can be stored in a memory associated with the computing device 100 and executed by an appropriate processor 101 and/or other processing circuitry.

A memory is defined herein as including both volatile and nonvolatile memory and data storage components. Volatile components are those that do not retain data values upon loss of power. Nonvolatile components are those that retain data upon a loss of power. Thus, the memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 101 may represent multiple processors 101 and the memory may represent multiple memories that operate in parallel processing circuits, respectively. The computing device 100 may also include one or more local interfaces through which the processor 101, integrated circuit 102, and/or other components can communicate. The processor 101 may be of electrical or of some other available construction.

Although the frequency selection module 105 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Additionally, although one specific implementation of the timing error module 109 is depicted in the accompanying drawings, it should be appreciated that alternative implementation of the timing error module 109 using varying logic gates that arrive at an equivalent or similar result are within the context of the present disclosure. The flowchart of FIG. 5 shows the functionality and operation of an implementation of portions of the frequency selection module 105. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 101 in a computer system or other system. The machine code may be converted from the source code, etc. If embodied in hardware, each block may represent a circuit or a number of interconnected circuits to implement the specified logical function(s).

Although the flowchart of FIG. 5 shows a specific order of execution, it is understood that the order of execution may differ from that which is depicted. For example, the order of execution of two or more blocks may be scrambled relative to the order shown. Also, two or more blocks shown in succession in FIG. 5 may be executed concurrently or with partial concurrence. Further, in some embodiments, one or more of the blocks shown in FIG. 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the frequency selection module 105 that comprises software, firmware, or code can be embodied in any non-transitory computer-readable medium for use by or in connection with an instruction execution system such as, for example, a processor 101 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, having thus described the invention, at least the following is claimed:

1. A system, comprising:
a critical path flip flop positioned in a critical path of an integrated circuit, the critical path flip flop being coupled to an input signal and a clock signal;
a timing error module positioned in parallel with the critical path flip flop in the integrated circuit, the timing error module being coupled to the input signal and the clock signal, the timing error module operable to produce a delayed input signal and a delayed clock signal, the timing error module further configured to generate a timing error prediction based in part upon the delayed input signal and a timing error detection based at least in part upon the delayed clock signal; and
a voltage selection module executed by processing circuitry in a computing device, the voltage selection module configured to select a minimum voltage level associated with the integrated circuit based at least in part upon the timing error prediction and the timing error detection.

2. A system, comprising:
a critical path flip flop positioned in a critical path, the critical path flip flop being coupled to an input signal and a clock signal;
a timing error module positioned in parallel with the critical path flip flop, the timing error module being coupled to the input signal and the clock signal, the timing error module operable to produce a delayed input signal and a delayed clock signal, the timing error module further configured to generate a timing error prediction based in part upon the delayed input signal and a timing error detection based at least in part upon the delayed clock signal.

3. The system of claim 2, wherein the timing error module further comprises a first delay module configured to generate a delayed input signal and a second delay module configured to generate a delayed clock signal.

4. The system of claim 3, wherein the first delay module and the second delay module are operable to generate a configurable delay of an input signal.

5. The system of claim 3, wherein the first delay module and the second delay module comprise a first series of inverters, an output of the first series of inverters being coupled to a first multiplexer input and an input of a second series of inverters, and an output of the second series of inverters being coupled to a second multiplexer input.

6. The system of claim 3, further comprising a first flip flop and a second flip flop, the delayed input signal being supplied to an input of the first flip flop and the delayed clock signal being supplied to an input of the second flip flop.

7. The system of claim 6, further comprising:
a first XOR gate, wherein an output of the first flip flop and an output of the critical path flip flop are supplied to inputs of the first XOR gate; and
a second XOR gate, wherein an output of the second flip flop and the clock signal are supplied to inputs of the second XOR gate.

8. The system of claim 7, wherein the output of the first XOR gate is associated with the timing error prediction and the output of the second XOR gate is associated with the timing error detection.

9. The system of claim 8, wherein a true output of the first XOR gate is associated with the timing error prediction and a true output of the second XOR gate is associated with the timing error detection.

10. The system of claim 2, further comprising a frequency selection module configured to increase a clock frequency when the timing error prediction and the timing error detection do not indicate a timing error.

11. The system of claim 10, wherein the frequency selection module selects an increased delay for the delayed input signal and the delayed clock signal when the timing error prediction indicates a timing error.

12. A method, comprising:
providing an input signal to a critical path flip flop positioned a critical path of an integrated circuit, the flip flop being clocked by a clock signal;
providing the input signal and the clock signal to a timing error module positioned in parallel with the critical path flip flop, the timing error module producing a delayed input signal and a delayed clock signal;
generating, by the timing error module, a timing error prediction based in part upon the delayed input signal and a timing error detection based at least in part upon the delayed clock signal and the delayed input signal.

13. The method of claim 12, further comprising selecting a maximum clock frequency of the integrated circuit based at least in part upon the timing error prediction and the timing error detection.

14. The method of claim 12, further comprising providing, by the timing error module, the delayed input signal to a canary flip flop clocked by the clock signal, an output of the canary flip flop being coupled to an input of a XOR gate, an output of the critical path flip flop being coupled to another input of the XOR gate.

15. The method of claim 14, wherein the timing error prediction comprises an output of the XOR gate.

16. The method of claim 15, wherein the timing error prediction is true when the output of the canary flip flop and the output of the critical path flip flop are unsynchronized.

17. The method of claim 14, further comprising providing, by the timing error module, the delayed input signal to a shadow flip flop clocked by the delayed clock signal, the output of the shadow flip flop being coupled to an input of another XOR gate, the output of the critical path flip flop being coupled to another input of the other XOR gate.

18. The method of claim 17, wherein the timing error detection comprises an output of the other XOR gate.

19. The method of claim 18, wherein the timing error detection is true when the output of the canary flip flop and the output of the critical path flip flop are unsynchronized.

20. The method of claim 13, further comprising increasing the clock frequency when the timing error prediction and the timing error detection do not indicate a timing error.
